(19) United States
(12) Patent Application Publication
(10) Pub. No.: US 2018/0300783 A1
(43) Pub. Date: Oct. 18, 2018

(54) SERVICE AREA AND RATE TOOL FOR ONLINE MARKETPLACE

(71) Applicants: David LoPresti, Surprise, AZ (US); Cameron Michael Young, Scottsdale, AZ (US)

(72) Inventors: David LoPresti, Surprise, AZ (US); Cameron Michael Young, Scottsdale, AZ (US)

(21) Appl. No.: 15/952,423

(22) Filed: Apr. 13, 2018

Related U.S. Application Data
(60) Provisional application No. 62/485,300, filed on Apr. 13, 2017.

(51) Int. Cl. G06Q 30/06; G06Q 10/06

(52) U.S. Cl. CPC G06Q 30/0611; G06Q 10/06311

(57) ABSTRACT

A computer system provides an online marketplace for services related to moving. The system includes a processor and a database for storing information about services offered by a provider in the marketplace. The system can display on a computer device of a provider webpages configured to enable the provider to: define one or more customized geographic coverage areas in which the provider offers or desires to offer services via the online marketplace by drawing the boundaries of the geographic coverage area on a map; designate, for each of the one or more geographic coverage area, the types of services that the provider offers or desires to offer in the geographic coverage area and one or more rates charged by the provider for each of the types of services.

### RELATED APPLICATIONS

This application claims priority of, and incorporates by reference, U.S. provisional patent application Ser. No. 62/485,300, filed Apr. 13, 2017 entitled Service Area and Rate Tool for Online Marketplace.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

The present invention relates generally to customer/vendor marketplaces in a computer network environment. More specifically, the invention relates to an online marketplace rate tool for service providers to transact business for services related to moving. The marketplace tool allows for service providers to designate their coverage area, synchronize their online marketplace calendar with their existing calendar applications, accept a payment code and to receive payment.

Presently, there are a number of companies that provide online marketplaces for customers and service providers (referred to in this document as vendors), to transact business. An example of one such a marketplace is the eMove® online marketplace that is operated by eMove, Inc. for services related to moving and relocating. The structure and operation of one version of the Moving Help® online marketplace is described in U.S. Pat. No. 8,135,627 to Shoen, et al., entitled “Online Marketplace for Moving and Relocation Services,” which is incorporated herein in its entirety by this reference. With the Moving Help® online marketplace, moving customers can seek help for a wide variety of services related to moving and relocating, such as loading and unloading of a vehicle or trailer, packing and unpacking and other common chores associated with moving. The marketplace allows such customers to enter into transactions with vendors offering such services. With the online marketplace, customers can estimate the amount of labor they will need and make arrangements for paying the selected vendor. Previously, the Moving Help® online marketplace allowed a vendor having an account with the marketplace to select a square-shaped “coverage area,” i.e., a geographic zone or area the vendor has chosen to service—meaning that if a customer needs to book an order at an address that falls inside that coverage area, that vendor is a candidate to be chosen for that job. It would be beneficial to vendors as well as customers, however, to provide a more flexible tool to vendors for defining service coverage areas and setting the vendors' rates for those areas.

An object of the present invention is to provide a service area and rate tool for an online marketplace that allows service providers (also referred to in this specification as “vendors”) to transact business for services related to moving.

Another object of the present invention is to provide such a flexible online marketplace tool, which allows service vendors to define multiple coverage areas and services offered in those areas and which allows the vendors to set rates in each of the areas under various conditions.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a computer system for providing an online marketplace for services related to moving. The system includes one or more processors and a database for storing information about services offered by a provider in the marketplace. The service information includes: one or more geographic coverage areas within which the provider offers services; one or more types of services offered by the provider in each of the one or more coverage areas, and one or more rates charged by the provider for each of the one or more types of services offered by the provider in each of the one or more coverage areas. A computer-readable memory is accessible by the one or more processors and includes programming instructions for displaying on a computer device of a service provider one or more webpages configured to enable the provider to: define one or more customized geographic coverage areas in which the provider offers or desires to offer services via the online marketplace by drawing the boundaries of the geographic coverage area on a map; designate, for each of the one or more geographic coverage area, one or more types of services that the provider offers or desires to offer in the geographic coverage area; and designate, for each of the one or more geographic coverage areas, one or more rates charged by the provider for each of the one or more types of services that the provider offers or desires to offer in the geographic coverage area.

According to one aspect of the invention, the one or more webpages can be configured to display a menu for accessing a drawing tool configured to enable the provider to define boundaries of the one or more customized geographic areas by drawing an area on the map in the shape of a square, circle or polygon.

According to other aspects of the invention, the webpages can be configured: to enable the provider: to designate a first rate for a type service to be provided in a first coverage area and a different second rate for the same type for services to be provided in a second coverage area; to input days of the week and times when each of the one or more types of services will be available in each of the one or more geographic coverage areas; to specify how many jobs the provider can schedule for a time category and how many workers the provider has available for those jobs; to input for a type of service a maximum crew size offered and an hourly rate based on the crew size; to input for a type of service a maximum crew size offered and an hourly rate based on the crew size; to enable the provider to designate a rate based on the number of hours a customer orders; and/or to enable the provider to designate a rate based on the day of the week or time for which a customer order is scheduled.

The system allows service providers in the marketplace to draw multiple service coverage areas and to separately define offered services and rates for each specific coverage area. It provides vendors a higher level of customization when setting up their coverage area and services. With the system, vendors have the option to have just one coverage zone or area or as many as they would like to create with different services and rates offered in each zone. For example, a vendor can set up one smaller area to cover the geographic zone immediately around its base location and numerous other customized area to cover other geographic zones in which it offers services farther away from its base location. With the system, the vendor can charge a lower price for services in the coverage area directly surrounding its base location and higher prices for services in areas that are located farther away.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a functional block diagram of a preferred computer system and a network for practicing the present invention, including an online marketplace computer system and vendor computer devices.

FIG. 2 is a block diagram of an online marketplace application that includes a vendor application in accordance with one embodiment of the present invention.

FIG. 3 is a block diagram showing various tables of data and their relationships in accordance with one embodiment of the present invention.

FIG. 4 shows an exemplary display of a Coverage Area page of a website according to the present invention for starting the process of defining coverage areas and corresponding services to be offered in those areas.

FIG. 5 shows an exemplary display of a Coverage Area page of a website according to the present invention for creating geographic zones to define service coverage areas.

FIG. 6 shows the Coverage Area page FIG. 5, depicting a service coverage area defined in the shape of a polygon.

FIG. 7 shows an exemplary embodiment of a Coverage Area/Availability of a website according to the present invention for providing a service vendor the option to select what days and times the vendor's services are available in a specific coverage area.

FIG. 8 shows the Coverage Area/Availability page FIG. 7, depicting drop down selection options for specifying time slots for each day of the week and the maximum number of jobs that a vendor can accept in each time slot.

FIG. 9 shows an exemplary display of a Coverage Area/Services page of a website according to the present invention for selecting the services that a vendor will offer in a given coverage area.

FIG. 10 shows the Coverage Area/Services page FIG. 9, depicting options for setting a crew size and discount rate for a specific service that the vendor will offer.

FIG. 11A shows the Coverage Area/Services page FIG. 9 displaying the selected settings for crew size and rates for a given service to be offered on a given day.

FIG. 11B shows another embodiment of a Coverage Area Services page displaying selected settings for driving help services and rates.

FIG. 12 shows an exemplary display of a Coverage Area page for activating a coverage area defined by the vendor.

FIG. 13 shows the Coverage Area page of FIG. 4 displaying a coverage area that has been defined and activated by the vendor.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

One embodiment of an online marketplace according to the present invention comprises a customer application, a vendor application, and an administrative application. The customer application processes input entered by a customer after the customer has entered the marketplace. The vendor application processes input entered by a vendor offering a moving-related service. The administrative application allows a marketplace host to maintain the marketplace and gather transactional data from the customer application and the vendor application. The online marketplace includes a vendor account interface that provides a service area and rate tool via which a vendor in the marketplace can define multiple service coverage areas and customize its services offered in those areas, its rates for such services and other aspects of its service offerings in the defined coverage areas.

### Computer Network System

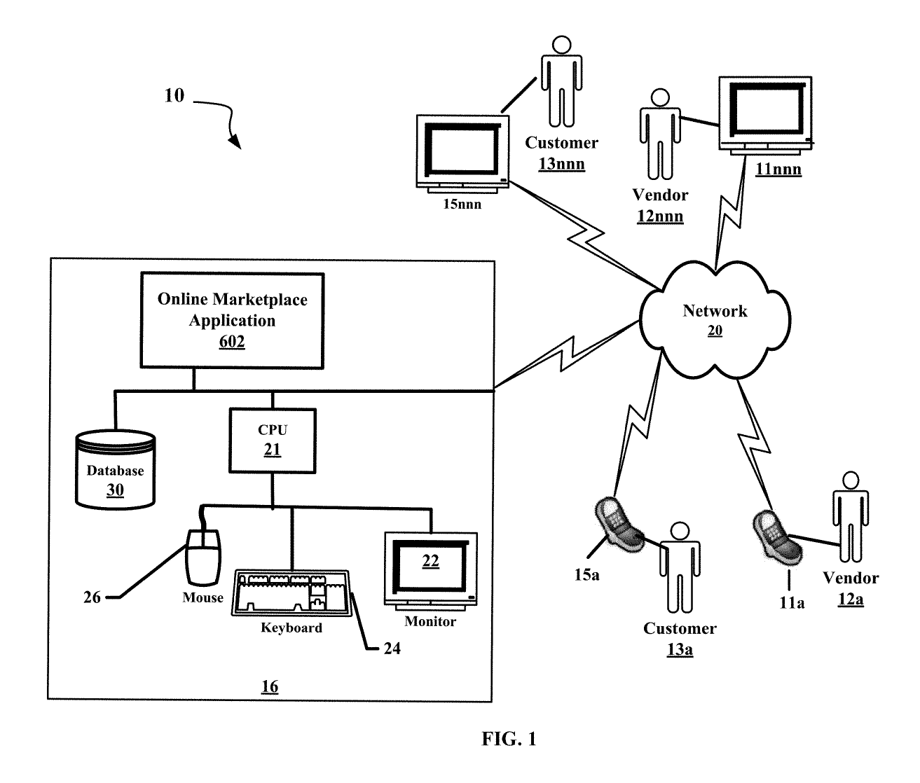

FIG. 1 illustrates a preferred computer network system 10 for practicing the present invention. The computer network system 10 includes a vendor marketplace computer system 16, which stores and processes the information described below. Service vendors 12a-12nnn can access and communicate with the vendor marketplace computer system 16 via vendor computer devices 11a-11nnn, (where nnn refers to any number of users and user devices) coupled to the vendor marketplace computer system 16 via a computer network 20, such as the Internet, or by other suitable communications means. In addition, in a presently preferred embodiment, customers 13a-13nnn can submit reservation requests or orders via customer computer devices 15a-15nnn coupled to the computer system 16 via the computer network 20. In a preferred embodiment of the invention, the computer network 20 comprises the Internet and the computer devices 11, 15 each have a web browser application for accessing content on the World Wide Web. The computer devices 11, 15 can be any device suitable for communication over the Internet, including without limitation, a desktop computer, smartphone, FDA, handheld mobile digital electronic device, tablet computer, portable computer or the like. Upon reading this specification, those skilled in the art will understand that, under appropriate circumstances, considering issues such as developments in computer hardware, software and connectivity, etc., other network configurations and devices also may suffice.

Still referring to FIG. 1, the marketplace computer system 16 includes a central processing unit (CPU) 21 for processing data and program instructions. The marketplace computer system 16 also includes input and output devices, as is well known in the art. For example, the marketplace computer system 16 preferably includes a display screen or monitor 22, a keyboard 24, a mouse 26, a printer (not shown), etc. The marketplace computer system 16 further includes data storage and memory devices, as are known in the art, for storing a database 30. The database 30 is used to store the data required by the online marketplace application 602 to provide the functionality described below. Preferably, the database 30 is a relational database, as is well known in the art. The online marketplace application 602 is operable with the database 30 and the computer devices 11, 15 to provide the functionality described below. In a presently preferred embodiment, the marketplace application program 602 is written using MVC, marketed by Microsoft Corporation. The database 30 is implemented using the SQL Server database management system, also marketed by Microsoft Corporation. Upon reading this specification, those skilled in the art will understand that, under appropriate circumstances, considering issues such as developments in computer hardware, software and connectivity, etc., other operating systems, programming languages and database management systems can be used.

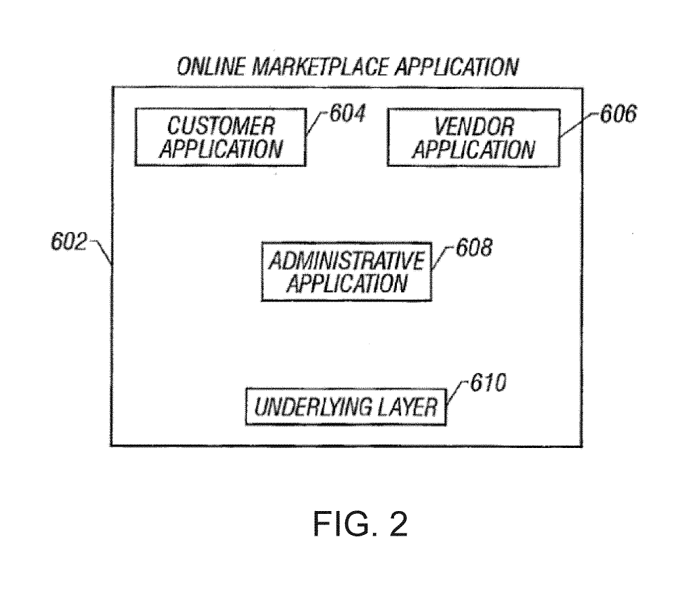

FIG. 2 is a block diagram of an online marketplace application in accordance with one embodiment of the present invention. The online marketplace application 602 contains four primary components: Customer Application 604, Vendor Application 606, Administrative Application 608, and Underlying Layer 610. Customer Application 604 allows the customer to navigate through the marketplace. It enables a customer to browse content of a selected vendor. It also provides the functionality of selecting and paying for a service from a particular vendor. After the service is completed, it provides the functionality for accepting feedback and comments from the customer regarding the vendor. It also allows a customer to review the transactions that have been paid for before and after a job is completed.

Vendor Application 606 provides functionality for vendors to complete necessary tasks. Initially, it processes vendors being added to the lists maintained by the host. It handles the logging on process for vendors entering the marketplace and processes confirmation codes entered by a vendor to transfer money from an account to the vendor's account. It also processes scheduling services for the vendors and provides schedules to vendors. Administrative Application 608 allows an administrator of the online marketplace to oversee the entire application and perform basic administrative functions. A few examples of this include assigning a particular city to a service area or adding a new category of services to the services offered in the marketplace. It also allows an administrator to access data for analysis and creating statistics on customer behavior. Underlying Layer 610 provides the groundwork or foundation for the applications to function. For example, it maps the database for the applications and determines the overall look and feel of the online marketplace application.

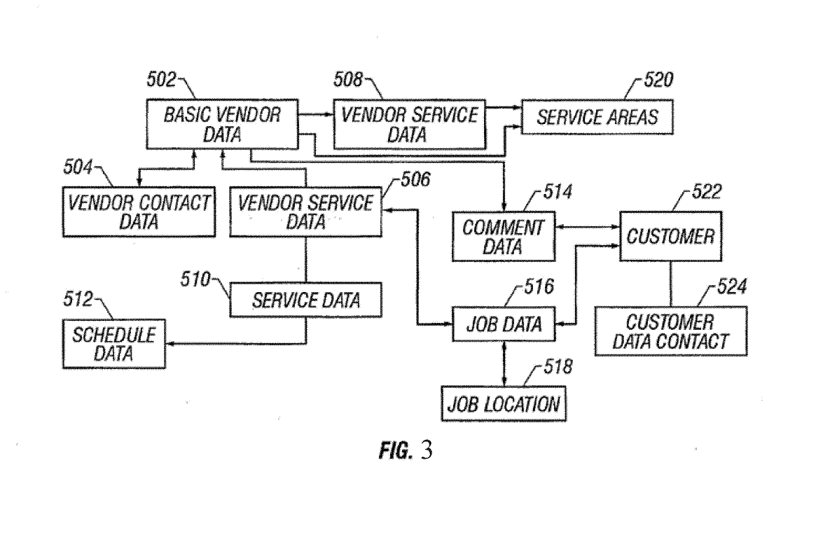

FIG. 3 is a block diagram showing various tables of data and their relationships in accordance with one embodiment of an online marketplace according to the present invention. Information regarding a specific vendor is stored in separate tables that include: Basic Vendor Data 502, Vendor Contact Data 504, Vendor Service Data 506, Vendor Service Data 508 and Service Area 520. The Vendor Contact Data table 504 contains data for identifying and contacting the vendor, such as address, cell phone number, and similar information. Basic Vendor Data table 502 contains other information such as a brief description of the vendor, status, password, photo URL, vendor ID, how long it has been a member, and so on. As with nearly all the tables, it also has pointers to related tables as shown in FIG. 3. Vendor Service Data table 506 contains information on the services offered by the vendor, such as rates and service identifiers. If a vendor offers only one service, this table will contain one record for the vendor. Vendor Service Data table 508 contains data on the areas serviced by the vendor. This list can include names of town, cities, metropolitan area, counties, and so on. A Service Data table 510 contains a list of all the broad categories of services available in the marketplace and is used by the online marketplace application to accept a service description from a customer and match the service with vendors offering the service, thus tables 510 and 506 share data. Service Data table 510 shares data with a Schedule Data table 512 which, in addition to the four vendor tables described above, also contains vendor specific data. Table 512 contains schedule data for a particular vendor, such as hours of operation for each day of the week. This data allows the marketplace application to handle scheduling between a customer and vendor.

### Vendor Account Interface

A vendor who has been registered (and thereby has an account) with the system accesses logs into the Vendor Application 606 to input and access information relating to the vendor's service offerings. Once logged in, the vendor lands on its Account Home page, which displays information such as the jobs scheduled for that specific day, the vendor's To Do List, News, etc. From the vendor's Account Home page, the vendor also can access various functions for using the online marketplace. According to the present invention, one such function allows the vendor to input information to define geographic areas of coverage and rates for services that the vendor offers. Data entered by the vendor is captured and used by the Vendor Application 606 as described below.

### Vendor Account Home Page

In one embodiment, the Account Home page (not shown) is the first page that the vendor is directed to after logging into its account. The main purpose of the Account Home page is to allow the vendor to quickly view new jobs that have been placed and jobs they have scheduled for that day, and to manage the vendor's to do list. The vendor's Account Home page can also include additional items and functionalities to help the vendor to better serve its customers by making communication easier and more user friendly.

In one exemplary embodiment, the Account Home page can include or provide access to the following items:
A “Daily Scheduled Jobs Menu” allows a vendor to view its jobs scheduled for a selected date as well as giving the vendor access to that day's customer contact information and job details.
A “Jobs Received since Last Login” dashboard display can detail any jobs that the vendor has received since last logging into its account. This can help notify the vendor about any new jobs that it has received since last using its account.
A “To Do List” (hereinafter referred to as the “TDL”) can notify a vendor of any jobs or updates regarding its account. This includes things such as new or cancelled jobs, new reviews, etc. Some items posted in the TDL may require that a specific action be taken, while others may simply be information that can be easily dismissed and removed from the TDL after being viewed. Most of the items generated into the TDL can be automatically generated based on certain actions that occur through the website. For example, if a job is cancelled, a TDL item notifying the vendor that its job with “First Name, Last Name” has been cancelled will be generated and placed in the TDL automatically. There will be some instances where Administration will be able to manually send and place in the TDL custom items to a specified vendor or group of vendors.
A “job Details Page” can be accessed from the vendor's. Job Numbers, Customer Names, and even links titled “View Job Details” can link back to the “Job Details Page.” The purpose of the “Job Details Page” is to give the vendor all the specific information regarding its scheduled customer, such as contact information and moving addresses, and also the requested service details (job type and men and hours requested).
A “FAQ” section can be composed of all the Frequently Asked Questions regarding the website and the vendor's account. The FAQs can range from general questions about services and pricing to account questions about payment types and reviews. The two main functions of the FAQs are “Search” and “Administration editing” capabilities.
A “Job Calendar” lists specific jobs that a vendor has scheduled by linking the customer's last name and placing it on the date that the job is scheduled (the last name is linked to the “Job Details Page” for that specific order). The vendor can view the
“Job Calendar” in two ways: (1) Weekly View, which shows the week starting on Sunday through Saturday, or (2) Monthly View, which shows the whole month.
Vendors can be given great flexibility and customization within their own “Job Calendar.” They have the ability to add and track jobs that they have scheduled outside of the marketplace as well as appointments and vacations. When the “My Calendar” tab is clicked, the default calendar view will be for the current week. The Vendor can navigate to future and past weeks with arrow buttons that will be on each side of the current week's time frame.
A vendor also can be given options to set reminders for the events it adds to its calendar and can sync its calendar with its existing calendar applications such as iCal and Google Calendar.

### Vendor Services and Coverage Areas

According to one aspect of the present invention, service vendors can have a high level of customization when setting up their coverage area and services. In one embodiment, the system allows vendors to draw an unlimited number of polygons, circles, or squares and then setting up their availability, offered services, and rates for each specific coverage area they create. With this added functionality, service providers no longer need to include a travel charge for coverage areas that require them to travel longer distances to provide a service. Instead, they can account for this travel using the polygon rate system by drawing one coverage area that covers customers within a short distance from the service provider, and they can offer services for a lower price because the service provider does not have to travel far. That same service provider can then draw a coverage area that covers customers a greater distance away, and the provider can then charge a completely separate rate, which would most likely be higher to cover the service provider's travel expenses. This customization feature enables service providers to avoid charging a travel surcharge because they are able adjust the price of their services based on the distance that a given coverage area is from the home base.

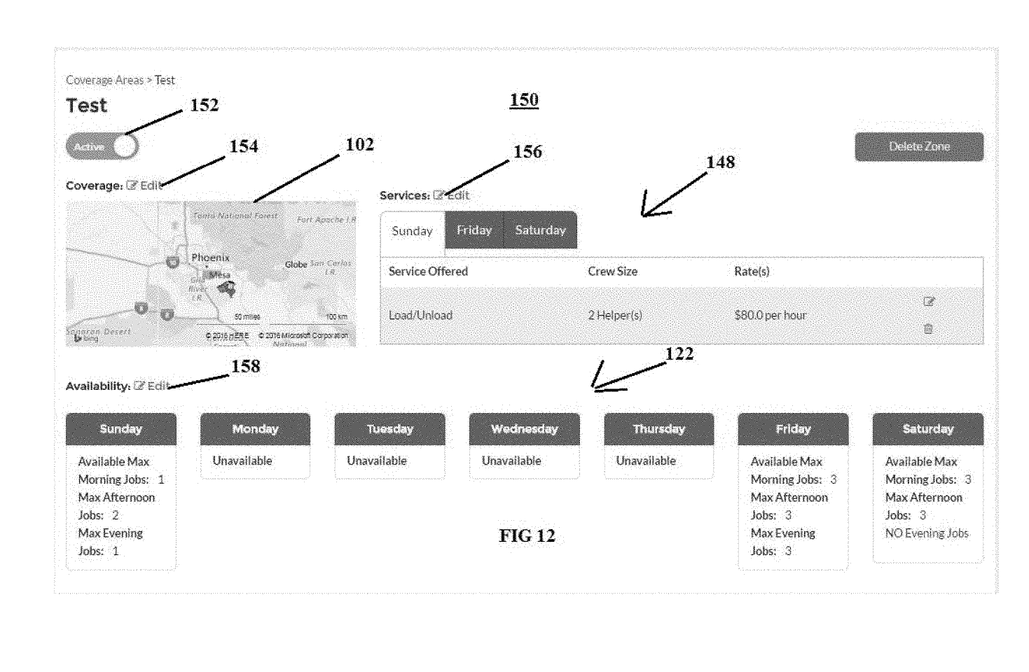

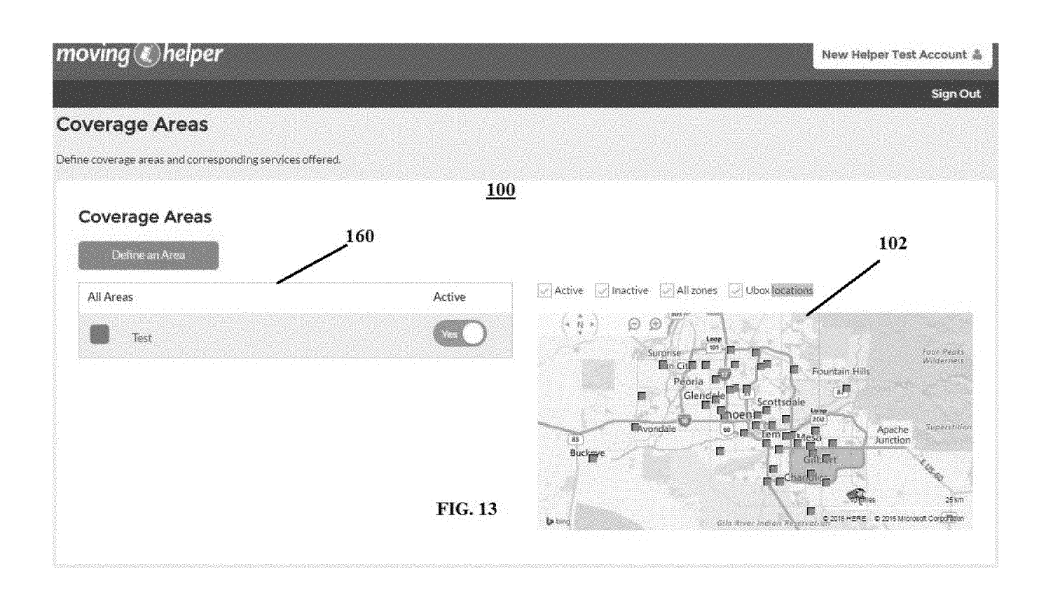

FIGS. 3-13 show exemplary web pages that are served by the marketplace computer system 16 to a vendor computer 15 and through which a vendor can view and input information regarding service coverage areas or zones as well as the types of services, rates and other information relating to the services offered by the vendor.

### Drawing Coverage Areas

According to one exemplary embodiment of the invention, service providers have the option to draw a square, circle, or polygon to represent their desired coverage areas. A service provider can have as little as one coverage area or as many as the service provider would like to create. This allows a service provider to have one smaller coverage area to cover the geographic areas immediately around its base address and any number of other customized coverage areas to cover any other areas in which the service provider may want to offer services further away from its home base. With this feature, service providers can charge a lower price for services in the coverage area directly surrounding their base address and charge higher prices for services that are located in areas that are much further away.

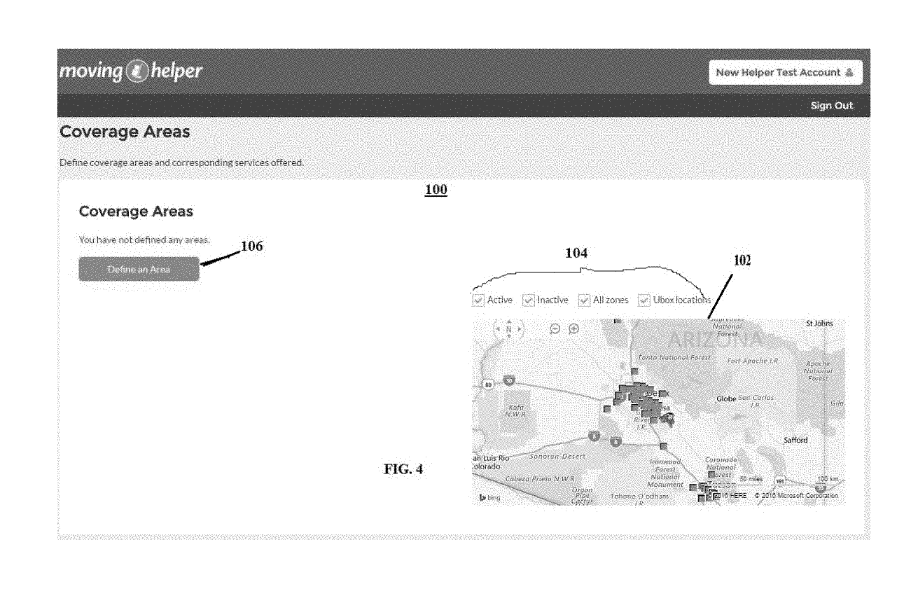

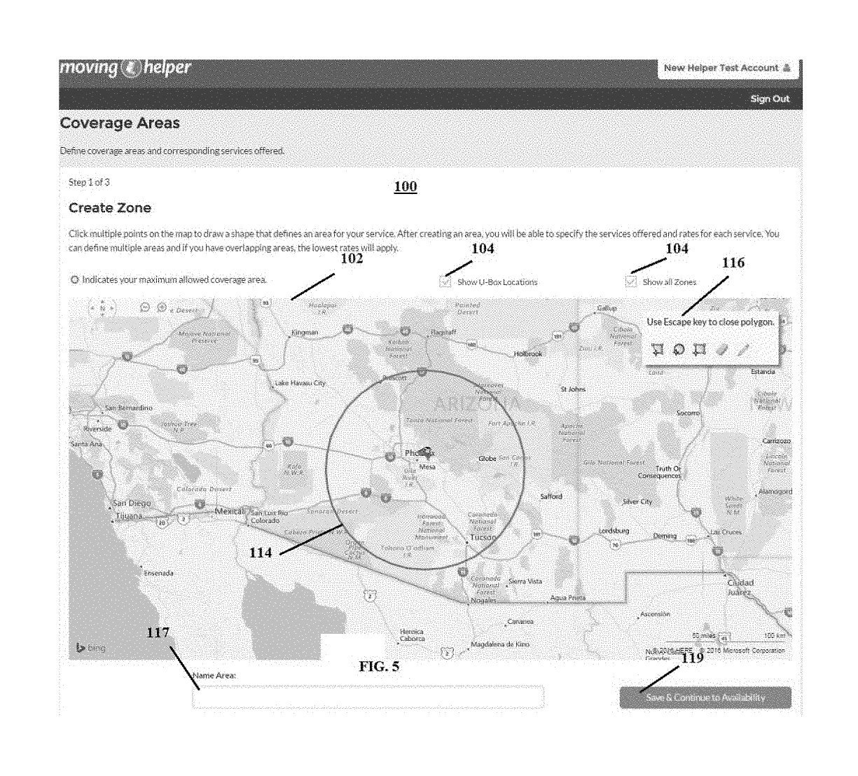

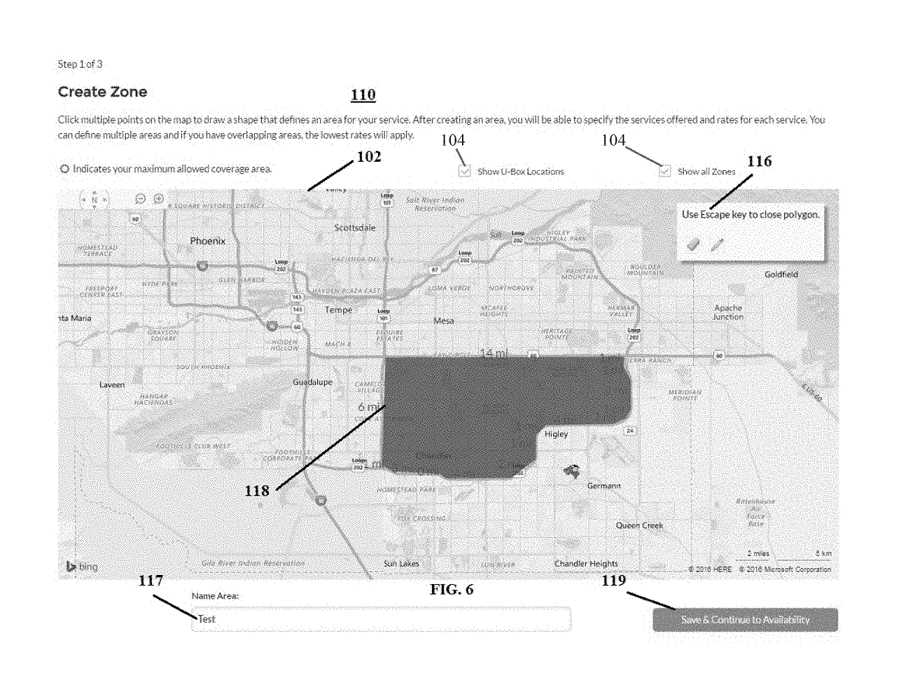

FIG. 4 shows an exemplary display of a Coverage Area page 100 that is served by the marketplace computer system 16 to the service provider computer 15 for defining coverage areas and corresponding services to be offered. The Coverage Area page 100 includes a map display 102, check boxes 104 for selecting items to show in the map display, and a Define an Area button 106. When the vendor 13 selects the Define an Area button 106, the system displays a Coverage Area/Create Zone page 110 like that shown in FIGS. 5 and 6, which displays the vendor's maximum allowed coverage area 114, a drawing tool menu 116 for creating a new coverage zone and a Name Area field 117 for naming the new coverage zone. By requiring a unique name for each coverage zone that a vendor creates and sets up the necessary information, the system makes it easier for the vendor to keep track of multiple separate coverage areas. For example, if a vendor draws five coverage areas, one for jobs within 20 miles of the provider's home address, and then four representing areas from 20 to 50 miles to the northwest, northeast, southwest and southeast, the vendor could name those areas “Home”, “Northeast”, etc. or other name that it sees fit.

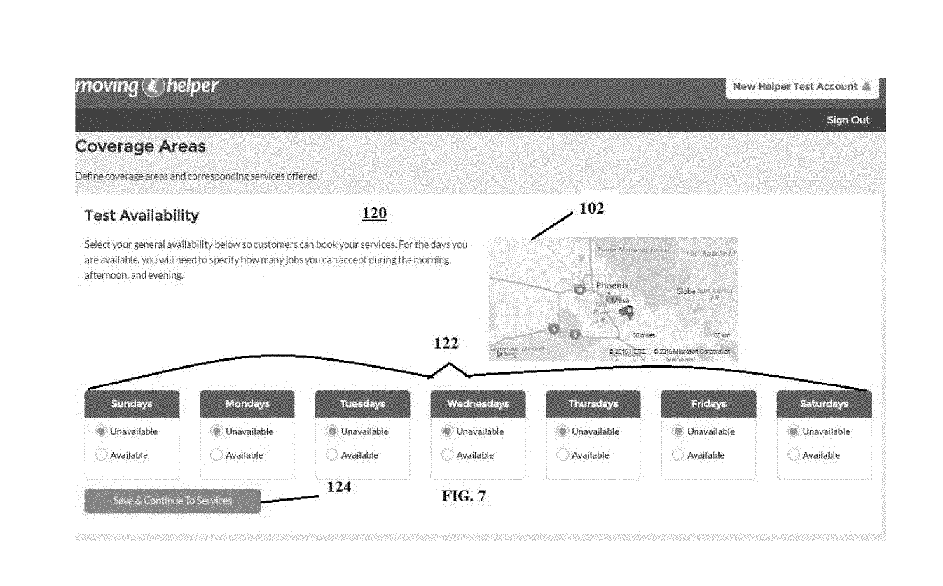

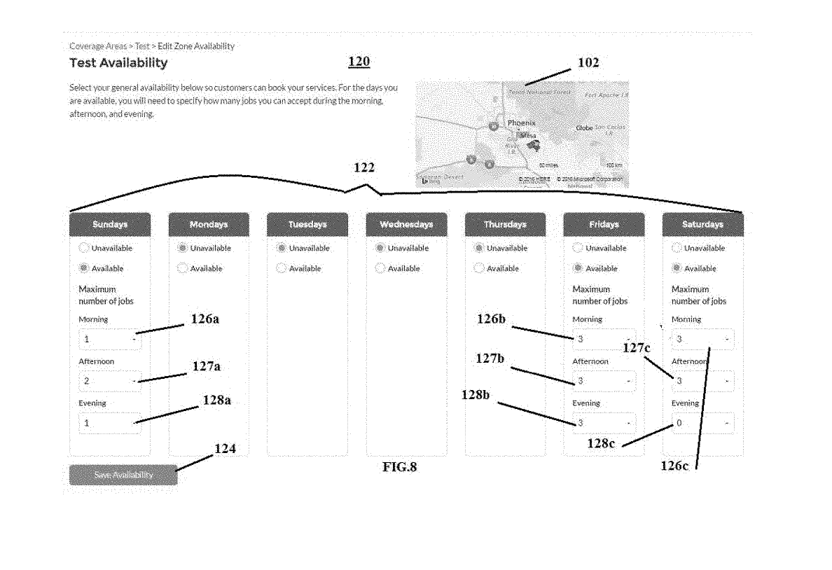

According to one embodiment of the invention, the drawing tool menu 116 can be used to draw a coverage area or zone in the shape of a circle, a square or a polygon. FIG. 6 illustrates an example of new coverage area created in the shape of a polygon and named “Test.” After the coverage zone is created, the service provider can save it by selecting a Save and Continue to Availability button 119, which causes the marketplace computer system 16 to save the information entered for the new zone and to display a Coverage Area/Availability page 120, like that shown in FIGS. 7 and 8, to give the service provider the option to select what days and times they want to be available in the new coverage area. For example, a service provider may want to be available Monday through Thursday for customers in a coverage area 50 miles north of the provider's home location and only be available Friday through Sunday for customers located in the coverage area 50 miles south.

After creating a coverage zone, a vendor can use the vendor application 606 of the marketplace application 602 to customize the service availability, offerings, and rates for that coverage zone. Referring to FIGS. 7 and 8, one exemplary embodiment of the Coverage Area/Availability page 120 includes availability selection buttons 122 for selecting the days of the week when the vendor is available to provide services in the coverage area. As shown in. FIG. 8, after the vendor selects the button showing availability for a given day, the Coverage Area/Availability page 120 displays additional drop down selection options for time categories in the Morning 126, Afternoon 127 and Evening 128 of that day. For each time category, the vendor can then specify how many jobs it can schedule for the category and how many workers the vendor has available for those jobs. The vendor can choose availability from 0-3 jobs per time category of Morning, Afternoon, Evening, with a maximum of 9 jobs per day. If a customer requests extra hours, the maximum daily amount will be overridden and the additional hours will be charged to the customer at the hourly rate that the vendor has set at the time of the order.

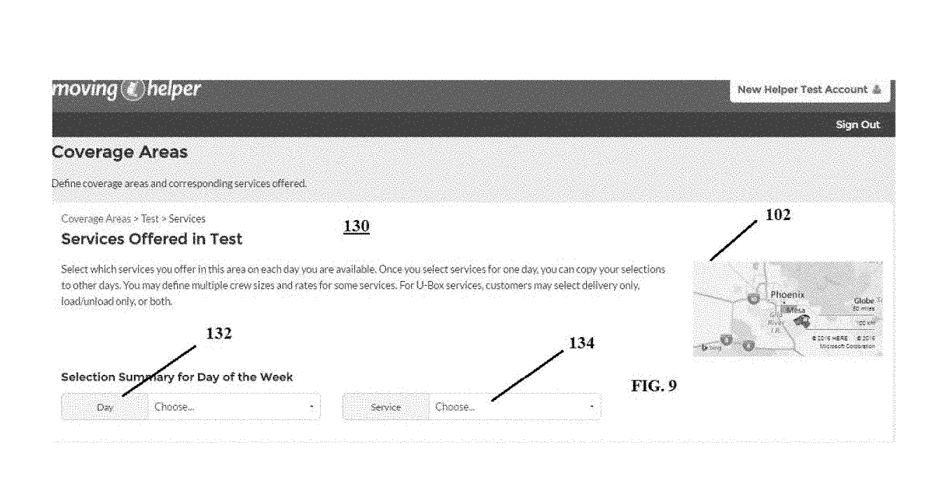

For each separate coverage area that is drawn, the vendor has the option to choose the types of services it wants to provide in a specific area. For example, if a vendor has a coverage area surrounding its home address and another coverage area that covers addresses outside of 50 miles, it can choose to provide loading/unloading and packing services in the area around its home address, but only loading/unloading services in the area that is much further away. FIGS. 9-11 show an exemplary display of a Coverage Area/Services page 130 for selecting the services that the vendor will offer in the subject coverage area on each day that the vendor is available. The Coverage Area/Services page 130 includes Day of the Week drop-down menu 132 for selecting a specific day of the week and Service drop-down menu 134 for selecting the applicable services. In one exemplary embodiment, available services that a vendor can. choose to offer are as follows:
Load/Unload
   Select 1 through 5 helpers (i.e., crew members)
   Specify Dollar Amount Per Hour for each crew size
Pack/Unpack
   Select 1 through 5 helpers
   Specify Dollar Amount Per Hour for each crew size
Maid Services/Home Cleaning
   Select 1 through 5 Helpers
   Specify Dollar Amount Per Hour for each crew size
Rental Truck Driving
   Select a mileage range and the price per mile for that range
   Moving Helpers should be able to create multiple mileage ranges
   For example, they can charge $2/mile for orders from 25 to 100 miles, $4/mile for jobs from 101 to 250 miles, and $6/mile for jobs over 250 miles.
   This is just an example, it will be customizable so that the vendor can choose any mileage breakdowns they would like and the dollar amount per mile for each mileage breakdown.
Storage Container Load/Unload (2-Helper Service)
   Price for the first box
   Price for each additional box
Storage Container Delivery and Load/Unload (2-Helper Service)
   Price to load/unload for the first box
   Price to load/unload each additional box
   Per Mile Driving Fee (Rate for first Box, Rate for Additional Boxes)
Storage Container Delivery Only (1-Helper Service)
   Delivery fee for first box
   Delivery fee for each additional box
   Per Mile Driving Fee (Rate for first Box, Rate for Additional Boxes)

In some embodiments, the available services can include specialty services for moving items such as pianos, safes and other specialty services. The most common items that people find difficult to move are pianos, hot tubs, and safes. All of these items normally require specialty equipment in order to ensure that they can be safely moved. The online marketplace can be used to let vendors know that providing these services often requires specialty equipment and training and that by signing up for them they are aware it is more complicated than moving boxes, etc. For example, if a vendor selects such services, Coverage Area/Services page could alert the vendor by displaying a message such as “Be aware, by offering to provide these specialty services you understand they can be difficult and often required additional training and equipment.” In one embodiment, piano and safe moving can be shown and offered as their own separate services that are charged as a flat rate instead of a per hour rate, and the online marketplace only allows vendors with the proper equipment to sign up and offer these types of services.

In certain embodiments, the online marketplace provides the administrator the option to turn on certain services in the vendor accounts. For example, hot tubs are common items that customers need moved but not all vendors have the ability to move these items. If requests for hot tub moving services become popular, the administrator can add that service as an option in the vendor account so that vendors can easily choose to provide or not provide that service. Being able to add and turn on services for vendors to select, if they choose to do so, allows the online marketplace to expand into offering other specialty services such as plumbing, painting, etc.

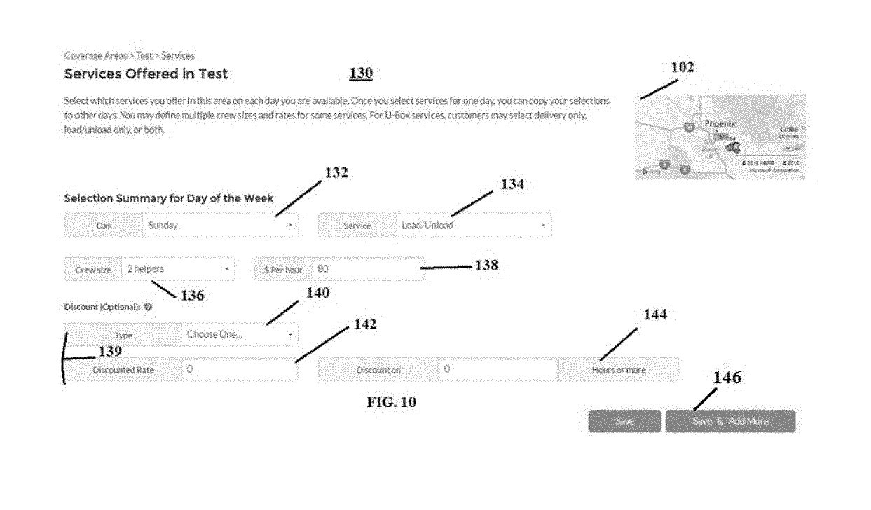

Referring again to FIG. 10, after the vendor selects a service to be offered in the coverage area, the Coverage Area/Services page 130 displays a Crew Size drop-down menu 136 for selecting a crew size for the specific service and $ Per Hour field 138 for inputting the rate for the service. The vendor has the option to choose how many crew members it wants to provide for each service and also the hourly rate for the service based on the crew size. For example, a vendor may need to have the ability to offer up to a five-man crew for loading jobs, but only a two-man crew for packing jobs. Each separate service that is offered can have its own crew size and its own price per hour based on the crew size. An example would be that for an area very close to a vendor's home address, it may offer up to a five-man crew, but for an area 50 miles away from the vendor's home address they may only want to offer a maximum of a two-man crew.

### Storage Container Services

In certain embodiments, for each coverage area that a vendor draws, it will have the option to provide the storage container services listed above. As can be seen in FIG. 6, When drawing a coverage area, the vendor can select the appropriate check box 104 above the map to show the locations of storage container centers in their area. If a storage container is included within the coverage area that the vendor draws and the vendor has turned on storage container services within this area, the vendor is indicating that it is willing to provide such service for customers and centers within this coverage area. Just as with the basic services, the vendor can choose its rates for storage container services within each coverage area that it draws. Vendors can have their storage container services turned on in some of their specific coverage areas and turned off in others. Vendors can sign up for all of the storage container services listed, or offer them independently.

Storage Container Coverage Areas. When a vendor draws a coverage area and has storage container services turned on, they are agreeing to provide those services for any of the storage container center locations (i.e., storage container supply locations) and customer locations within that coverage area. The rate that the vendor receives for the services is based on the customer location regardless of the storage container pickup location within the area.

Storage Container Relocation Issues. When a storage container center location does not have a sufficient number of containers and the order is changed to a location that is in a different coverage area than the original order, the storage container center team member or the vendor moving the storage containers also needs to be informed if there is going to be a price change for the new location. For example, if the containers are being moved to a different coverage area where the vendor charges a higher rate, the person moving the containers needs to be informed of this new rate so that they can properly inform the customer of the additional cost or whether the storage container supplier will pay the vendor for the overage. If the storage container is being moved to a location where the original vendor does not provide storage container services, the person moving the container needs to be notified so that they can look for a new vendor who does service the new area.

### Setting Discounted Rates

For each separate coverage area that a vendor draws and customizes, it has the option to charge a discounted rate or premium rate. For example, if a vendor wants to offer a percentage discount for jobs occurring on Saturdays and Sundays, it can select to offer a 10%, 15%, 20%, or 25% discount for jobs placed on these days. Also, a vendor can set a discounted rate after a certain amount of hours.

Still referring to FIG. 10, the Coverage Area/Services page 130 displays a Discount section 139 to give the vendor the option to offer a discounted hourly rate based on the number of hours the customer orders. The Discount section 139 includes a Type drop-down menu 140 for selecting the type of discount (e.g., a fixed discount or a percentage discount), a Discounted Rate field 142 for entering the amount or percentage of the discount, and a Discount On field 144 for entering the booked number of hours after which the discount will apply. For example, the vendor can charge $50/hour for a two-man/two-hour job, but then for any hours after two, the vendor can decrease the rate to $40 per hour. The vendor can set the number of hours booked before charging the discounted rate along with the amount of the discount. The vendor can customize these options for each separate service and each separate crew size it offers. For example, the vendor may choose to charge $50/hour for a two-man crew for three hours, but for every hour booked after the 3^{rd} hour, it may choose to charge only $40/hour. As another example, the vendor may choose to offer a discounted hourly rate for every hour after the 3^{rd} hour for a two-man crew, but not offer a discounted rate for a three-man crew. Or the vendor may choose to offer the discounted rate after a set number of hours for all crew sizes. For each crew size, the vendor can decide the hourly threshold at which the discount kicks in along with the actual rate they want to charge for the discounted hours.

In some embodiments, the vendor can have the option to easily turn the discount on and off at any time. This allows the vendor to get more jobs by simply turning on the discount feature at any time they choose so that their prices become lower and more competitive.

### Driving Service and Different Per Mile Rates

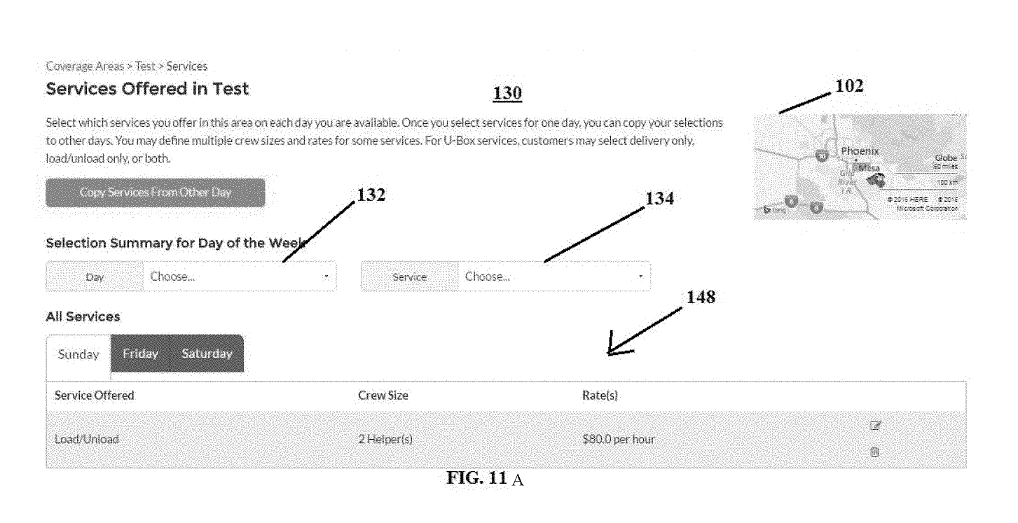

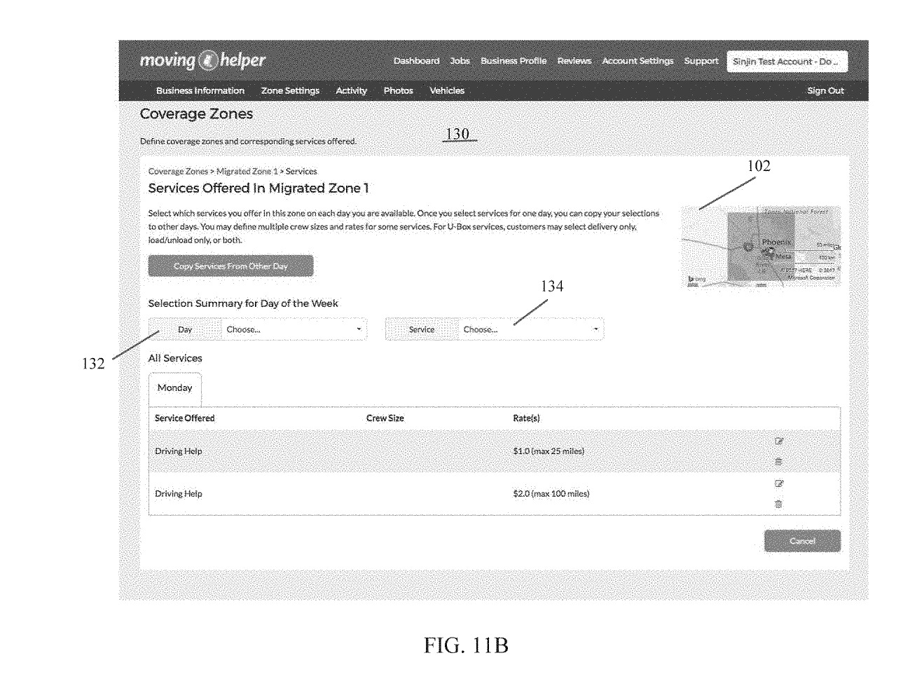

For each different coverage area that a vendor has drawn, it has the option. to provide driving services. As shown in FIG. 11B, for these services, the vendor can charge a different per mile rate based on distance. For example, a vendor may want to charge a lower per mile rate for distance under 25 miles, a slightly higher rate for a distance between 25 and 100 miles, and an even higher rate for a distance that is over 100 miles. In certain embodiments of the invention, a vendor has the option to set its own mileage breakdowns and the price per mile that it will charge for each mileage breakdown. For example, a vendor can create a mileage breakdown for any driving job from 37 to 83 miles, and then set the per mile price for this mileage breakdown. The vendor also can create additional mileage breakdowns with specific prices for each breakdown.

### Same-Day Service & Peak Hour Rates

In some embodiments, for each separate coverage area that a vendor draws and customizes, it has the option to provide same-day service—meaning customers will be able to place an order for a job to be scheduled and completed all on that same day. Also, in some embodiment, the vendor has the option to charge more than their normal rate during any peak hours for which it chooses to charge a higher rate.

Same-Day Service and Premium. For each coverage area that the vendor draws, it has the option to designate whether it wants to provide same-day service or not. This means that if the vendor has multiple separate coverage areas set up, it can choose to offer same-day service for any or all of those coverage areas. If the vendor wants to only offer same-day service for the coverage area that is closest to its base address and not for other coverage areas that are farther away, it has the option to do this. A vendor has the option to charge a premium for when a customer orders a same-day service. Same-day service jobs typically are booked with little advance notice to the vendor, and vendors may wish to charge the customer a premium in such circumstances. If the vendor chooses to charge a same-day service premium, it can customize the additional amount that it wants to charge the customer as a percentage of the normal cost. To do so, it can enter their desired premium in a box and that percentage premium will be applied to all services they offer. When entering the desired premium, the vendor can he shown how much that percentage is for each service. For example, if the vendor charges $50 per hour for a two-man job and wants to apply a 20% premium, once the premium is entered, the system can display the dollar amount of the charges including the premium, i.e. $60 an hour. If a vendor wants to charge a premium, it will need to turn on that function and also specify the percentage that it wants to charge.

Jobs Booked Late Night. Any job that is booked after a specified cutoff time (e.g., 6 PM local time) for a job that will occur on the next day, can be classified as a “Same-Day” order. It will incur any “Same-Day” premiums that the vendor has specified. The cutoff time is used because when an order is placed late at night, the vendor often may not be notified or be able to contact the customer or will not be notified due to the lateness of the order.

Jobs Booked Late Afternoon. If a vendor that provides same-day service does not have evening availability or only has availability until a given time (for example, 4:00 pm), the system can prevent customers ordering services shortly before that time (such as by at 3:00 pm in the present example) from booking an order with that vendor.

Peak Day Charges. In each coverage area that a vendor draws, it will have the option to set a peak day up-charge for days that it wants to charge more money for its services. When setting up its availability for each coverage area, the vendor is given an option to charge peak rates for any day that it wishes. For these days, the vendor can choose to charge an additional 10%, 25%, 50%, or 100% or a custom percentage. When selecting one of these percentages, there can be a visual calculator that shows the vendor how much additional money it will be charging based on the percentage that it chooses. The vendor can enter its desired premium in a field, and that percentage premium will be applied to all services it offers. When entering its desired premium, the vendor can also be shown how much that percentage is for each service. For example, if vendor charges $50 per hour for a two-man job and it wants to apply a 20% premium, after the vendor enters this premium, the system shows the vendor the premium it will receive—$60 an hour. If a vendor want to charge a premium they will need to turn on that function and also specify the percentage it wants to charge. For example, if a vendor wants to charge more money for jobs that are booked on Wednesdays, it can turn on the Peak Day Rate for Wednesday and then select the additional percentage it wants to charge for jobs that are placed on Wednesday. The vendor also has the ability to easily and quickly select or remove the days for which it wants to charge peak rates.

### Customer Account

With certain embodiments of an online marketplace in accordance with the present invention, a customer creates a customer account. Customers can log into their customer account through the “Login” section located on the online marketplace home page. Customers are instructed to create their customer account immediately after finishing their order for services. The purpose of the customer account is to provide a place where customers can handle all aspects of their move directly online through the online marketplace. In the customer account, customers have the ability to edit their order by adding hours, men, and even services. Customers can choose the services they want to add and simply charge the additional fees to the credit card that they provided when placing their order. Customers also have the ability to cancel an existing order and then use the funds they have already provided to place an order with a new vendor. If the cost of the new vendor happens to be more, they simply pay the difference and if the cost is less than the funds originally provided, the difference is refunded back to the customer's credit card.

Using their Customer Account, a customer can update their contact information, such as phone numbers and email addresses, and also view past orders. A Messaging Center provides customers with the ability to communicate directly with their vendor through the customer account. The customer can choose to opt-in and out of notifications via text and email. The notifications that the customer receives come from actions they take regarding their order, such as adding services or cancellations. The Customer Account also acts as a notification center, where customers can view and take action regarding any notifications they receive about their order. Customers can leave their vendor a tip if they feel like the job that was completed warrants one. In addition to the Dispute Resolution Center, customers have the opportunity to leave an updated review. If a Dispute Resolution Case is opened and closed, and the customer is happy with the results, they can decide whether to leave an updated review of the vendor.

Customers can create their customer account after placing an order through the online marketplace. Once the customer reaches the Create Account page, they must complete the required fields listed. In a one preferred embodiment, users will not have the ability to create an account until after they finish placing their order, i.e., a user must first become a customer with an order to create a Customer Account.

### CONCLUSION

Having read this specification, it will be apparent to those of skill in the art that the vendor services and rate tool of the present invention provides numerous benefits. The tool provides vendors a higher level of customization when setting up their coverage area and services. The tool allows vendors to draw multiple separate service areas (in the shape polygons, circles, or squares) when setting up the vendor's availability, offered services, and rates for each specific coverage area it creates. With the tool, a vendor has the option to have as little as one coverage area or as many as it would like to create. For example, the tool allows vendors to set up one smaller coverage area to cover the geographic zone immediately around its home or base location and to set up multiple of other customized coverage areas to cover other geographic zones in which it offers services farther away from its base location. With the tool, a vendor can charge different rates for each defined area. For example, the vendor can charge a lower price for services in the coverage area directly surrounding its base location and charge higher rates for services to be provided in areas that are farther away.

Upon reading this disclosure, additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

What is claimed is:

1. A computer system for providing an online marketplace for services related to moving, the computer system comprising:
one or more processors;
a database accessible by the one or more processors and configured for storing service information about services offered by a provider in the marketplace, wherein the service information includes:
one or more geographic coverage areas within which the provider offers services,
one or more types of services offered by the provider in each of the one or more coverage areas, and
one or more rates charged by the provider for each of the one or more types of services offered by the provider in each of the one or more coverage areas;
a computer-readable memory accessible by the one or more processors, the computer readable memory including programming instructions for displaying on a computer device of a provider one or more webpages configured to enable the provider to:
define one or more customized geographic coverage areas in which the provider offers or desires to offer services via the online marketplace by drawing the boundaries of the geographic coverage area on a map;
designate, for each of the one or more geographic coverage area, one or more types of services that the provider offers or desires to offer in the geographic coverage area; and
designate, for each of the one or more geographic coverage areas, one or more rates charged by the provider for each of the one or more types of services that the provider offers or desires to offer in the geographic coverage area.

2. The system of claim 1 wherein the programming instructions for enabling the provider to designate one or more rates charged by the provider for each of the one or more types of services offered by the provider in each of the one or more coverage areas comprises enabling the provider to designate a first rate for a type service to be provided in a first coverage area and a different second rate for the same type for services to be provided in a second coverage area.

3. The system of claim 1 wherein the one or more webpages are configured to display a menu for accessing a drawing tool configured to enable the provider to define boundaries of the one or more customized geographic areas by drawing an area on the map in the shape of a square, circle or polygon.

4. The system of claim 1 wherein the one or more webpages are configured to enable the provider to input days of the week and times when each of the one or more types of services will be available in each of the one or more geographic coverage areas.

5. The system of claim 1 wherein the one or more webpages are further configured to enable the provider to specify how many jobs the provider can schedule for a time category and how many workers the provider has available for those jobs.

6. The system of claim 1 wherein the one or more webpages are configured to enable the provider to input for a type of service a maximum crew size offered and an hourly rate based on the crew size.

7. The system of claim 1 wherein the one or more webpages are configured to enable the provider to input for a type of service a maximum crew size offered and an hourly rate based on the crew size.

8. The system of claim 3 wherein the one or more webpages are configured to enable the provider to designate a rate based on the number of hours a customer orders.

9. The system of claim 3 wherein the one or more webpages are configured to enable the provider to designate a rate based on the day of the week or time for which a customer order is scheduled.

10. The system of claim 1 wherein the one or more types of services related to moving include one or more of loading services, unloading services, packing services, unpacking services, maid services, home cleaning services, rental truck driving services storage container delivery services, storage container pick-up services, storage container loading services and storage container unloading services.

11. A method for providing an online marketplace for services related to moving, the method comprising:
storing in a database information about services offered by a provider in an online marketplace, wherein the service information includes:
a geographic area for each of one or more coverage areas wherein the provider offers services;
one or more types of services offered by the provider in each of the one or more coverage areas; and
one or more rates charged by the provider for each of the one or more types of services offered by the provider in each of the one or more coverage areas; and
with one or more processors in communication with the database, displaying on a computer device of the provider one or more webpages configured to enable the provider to:
define one or more customized geographic coverage areas in which the provider offers or desires to offer services via the online marketplace by drawing the boundaries of the geographic coverage area on a map;
for each of the one or more geographic coverage areas, designate one or more types of services that the provider offers or desires to offer in the geographic coverage area; and
for each of the one or more geographic coverage areas, designate one or more rates charged by the provider for each of the one or more types of services that the provider offers or desires to offer in the geographic coverage area.

12. The method of claim 11 wherein enabling the provider to designate one or more rates charged by the provider for each of the one or more types of services comprises enabling the provider to designate a first rate for a service type to be provided in a first coverage area and a different second rate for the same service type to be provided in a second coverage area.

13. The method of claim 11 wherein displaying the one or more webpages configured to enable the provider to define one or more customized geographic coverage areas comprises displaying a menu for accessing a drawing tool configured to enable the provider to define boundaries of the one or more customized geographic areas by drawing an area on the map in the shape of a square, circle or polygon.

14. The method of claim 11 wherein the one or more webpages are further configured to enable the provider to input days of the week and times when each of the one or more types of services will be available in each of the one or more geographic coverage areas.

15. The method of claim 11 wherein the one or more webpages are further configured to enable the provider to specify how many jobs the provider can schedule for a time category and how many workers the provider has available for those jobs.

16. The method of claim 11 wherein the one or more webpages are configured to enable the provider to input for a type of service a maximum crew size offered and an hourly rate based on the crew size

17. The method of claim 12 wherein the one or more webpages are configured to enable the provider to designate a rate based on the number of hours a customer orders.

18. The method of claim 12 wherein the one or more webpages are configured to enable the provider to designate a rate based on the day of the week or time for which a customer order is scheduled.

19. The method of claim 11 wherein displaying the one or more webpages are further configured to enable the provider to input for a type of service a maximum crew size offered and an hourly rate based on the crew size.

20. The method of claim 11 wherein the one or more types of services related to moving include one or more of loading services, unloading services, packing services, unpacking services, maid services, home cleaning services, rental truck driving services storage container delivery services, storage container pick-up services, storage container loading services and storage container unloading services.
